(19) United States
(12) Patent Application Publication
(10) Pub. No.: US 2005/0240693 A1
(43) Pub. Date: Oct. 27, 2005

(54) Method of establishing signal transmission between multi-functional peripheral device and host and device thereof

(75) Inventors: Kevin Liao, Hsin-Chu (TW); Jia-Ching Lee, Hsin-Chu (TW); Yao-Chung Liu, Hsin-Chu (TW); Lung-Hsiang Kai, Hsin-Chu (TW); Chi-Ming Lee, Hsin-Chu (TW); Chih-Kan Chang, Hsin-Chu (TW)

Correspondence Address: TROXELL LAW OFFICE PLLC;SUITE 1404, 5205 LEESBURG PIKE, FALLS CHURCH, VA, 22041, US

(73) Assignee: Ralink Technology, Corp.

(21) Appl. No.: 11/110,822

(22) Filed: Apr. 21, 2005

(30) Foreign Application Priority Data
Apr. 23, 2004 (TW) 093111531

(51) Int. Cl. G06F 13/12

(52) U.S. Cl. 710/62

(57) ABSTRACT

The present invention provides a multi-functional peripheral apparatus to be connected to a host. The apparatus comprises a connection module, a plurality of peripheral modules, and a control module. The connection module provides a transmission interface to receive a peripheral output signal from the host. Each of the peripheral modules performs a specific peripheral function. The peripheral modules further comprise a data storage memory to store at least one peripheral driver. The control module receives the peripheral output signal from the connection module and produces a corresponding peripheral control command to control and to enable the selected peripheral module specified in the peripheral output signal to perform the corresponding specific peripheral function. When the apparatus is connected to the host, the host allows the control module to install the peripheral driver into the host so that the host employs the driver to drive the selected peripheral modules.

### BACKGROUND OF THE INVENTION

1. Field of the Invention

The present invention relates to an apparatus and a method establishing a signal transmission between a multi-functional peripheral apparatus and a host, particularly to an apparatus with a plurality of functions for choosing.

2. Description of the Prior Art

A typical peripheral apparatus with multi-functional modules of the prior art utilizes a hub to connect with different functional modules. Besides, a typical multi-functional peripheral apparatus utilizes the communication between the hub and the host through several universal serial buses to switch different functions.

With reference to FIG. 1, FIG. 1 is a schematic diagram showing a typical multi-functional peripheral apparatus 12 of the prior art connected to a host 16. The l multi-functional peripheral apparatus 12 of the prior art comprises the first peripheral module 28 and the second peripheral module 30. The multi-functional peripheral apparatus 12 of the prior art utilizes a universal serial bus of a hub 14 to receive a signal 18 from the host 16. The signal 18 specifies the first peripheral module 28 or the second peripheral module 30 to perform specific corresponding peripheral functions. Based upon the signal 18, the multi-functional peripheral apparatus 12 of the prior art controls the first peripheral module 28 or the second peripheral module 30 by means of the first control module 24 or the second control module 26 through the first connection module 20 or the second connection module 22.

Because the multi-functional peripheral apparatus 12 of the prior art needs a hub 14 with a universal serial bus as a switch module, this method of employing hardware as the switch module is more complex in the manufacturing procedure and higher in cost. If the hub 14 is embedded in a multi-functional peripheral apparatus, the size of the apparatus is larger. Moreover, it is less convenient that the typical multi-functional peripheral apparatus 12 will further need an optical storage media storing its driver.

Therefore, the present invention aims provide an apparatus and a method for establishing signal transmission between a multi-functional peripheral apparatus and a host to solve the above technical problems of the prior art.

### SUMMARY OF THE INVENTION

Accordingly, an objective of the present invention is to provide a multi-functional peripheral apparatus and a method for establishing signal transmission between a multi-functional peripheral apparatus and a host to solve the technical problems of the prior art.

Another objective of the present invention is to provide a method for establishing signal transmission between a multi-functional peripheral apparatus and a host to install the peripheral driver of the multi-functional peripheral apparatus.

Another objective of the present invention is to provide a multi-functional peripheral apparatus and a method for establishing signal transmission between a multi-functional peripheral apparatus and a host to make use of software for switching different function modules to utilize different peripheral function through a universal serial bus.

The present invention provides a multi-functional peripheral apparatus to be connected to a host. The multi-functional peripheral apparatus comprises a connection module, a plurality of peripheral modules, and a control module. The connection module provides a transmission interface to receive a peripheral output signal from the host. Each peripheral module performs a specific peripheral function. The plurality of the peripheral modules further comprises a data storage memory to store at least one peripheral driver. The control module receives the peripheral output signal from the connection module and generates a corresponding peripheral control command to control and to enable a selected peripheral module specified in the peripheral output signal to perform the corresponding specific peripheral function. When the multi-functional peripheral apparatus is connected to the host, the control module installs the peripheral driver into the host so that the host can employ the driver to drive the selected peripheral module.

The multi-functional peripheral apparatus and the method for establishing signal transmission between the multi-functional peripheral apparatus and the host make use of software to switch between different peripheral modules through a single universal serial bus interface in order to utilize the corresponding specific peripheral functions. Moreover, the present invention directly installs the peripheral driver of the multi-functional peripheral apparatus into the host without the need of an optical storage media storing the peripheral driver.

The advantage and spirit of the invention may be understood by the following recitations together with the appended drawings.

### BRIEF DESCRIPTION OF THE APPENDED DRAWINGS

FIG. 1 is a schematic diagram showing a typical multi-functional peripheral apparatus 12 of the prior art connected to a host 16.

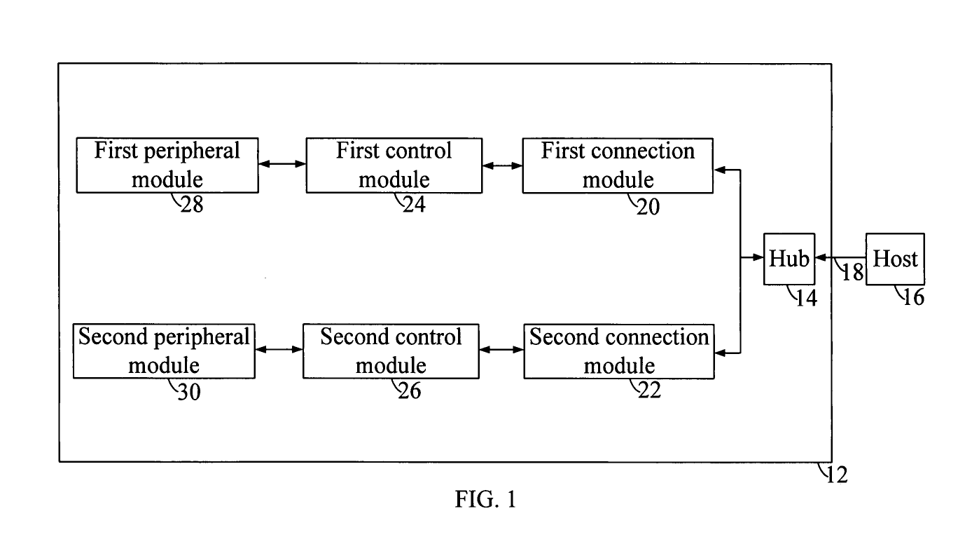

FIG. 2 is a schematic diagram showing a multi-functional peripheral apparatus of the present invention connected to a host.

FIG. 3 is a block diagram showing the multi-functional peripheral apparatus of another embodiment of the present invention.

FIG. 4 is a schematic diagram showing program installing and function switching after the multi-functional peripheral apparatus is connected to the host in FIG. 3.

FIG. 5 is a flow chart showing a signal transmission method for installing and function switching in the multi-functional peripheral apparatus in FIG. 4.

### DETAILED DESCRIPTION OF THE INVENTION

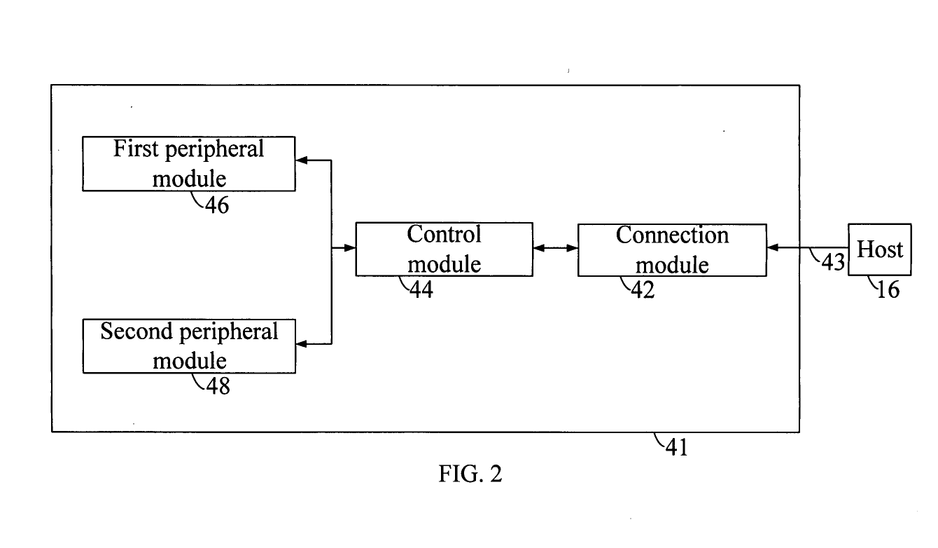

With reference to FIG. 2, FIG. 2 is a schematic diagram showing a multi-functional peripheral apparatus 41 of the present invention connected to a host 16. The multi-functional peripheral apparatus 41 comprises a connection module 42, a control module 44, and a plurality of peripheral modules. In FIG. 2, the multi-functional peripheral apparatus 41 further comprises the first peripheral module 46 and the second peripheral module 48. Each of the peripheral modules performs a specific peripheral function. The two peripheral modules 46, 48 comprise a data storage memory for storing a peripheral driver.

The connection module 42 provides a transmission interface for receiving a peripheral output signal 43 from the host 16. The control module 44 receives the peripheral output signal 43 from the connection module 42 and generates a corresponding peripheral control command, so as to control and to enable a selected peripheral module specified in the peripheral output signal 43 to perform the corresponding specific peripheral function.

When the multi-functional peripheral apparatus 41 is connected to the host 16, the host allows the control module 44 to install the peripheral driver, stored in the data storing memory, into the host 16, so that the host 16 can employ the driver to drive the selected peripheral module in the multi-functional peripheral apparatus 41.

The multi-functional peripheral apparatus 41 utilizes the connection module 42 to receive the signal 43 from the host 16, and the control module 44 enables the first peripheral module 46 or the second peripheral module 48 to perform the corresponding specific peripheral function according to the signal 43. Because the multi-functional peripheral apparatus 41 of the present invention makes use of software, by utilizing the connection module and the control module, instead of hardware, like the hub, the cost can be lowered.

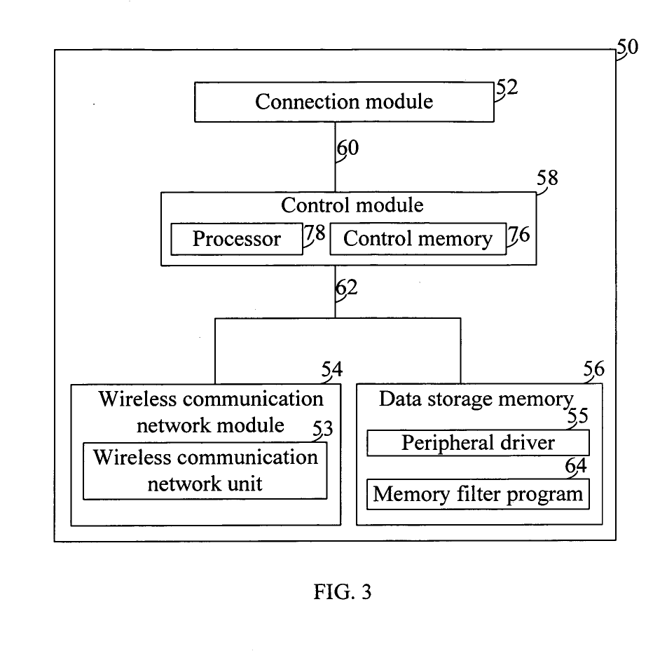

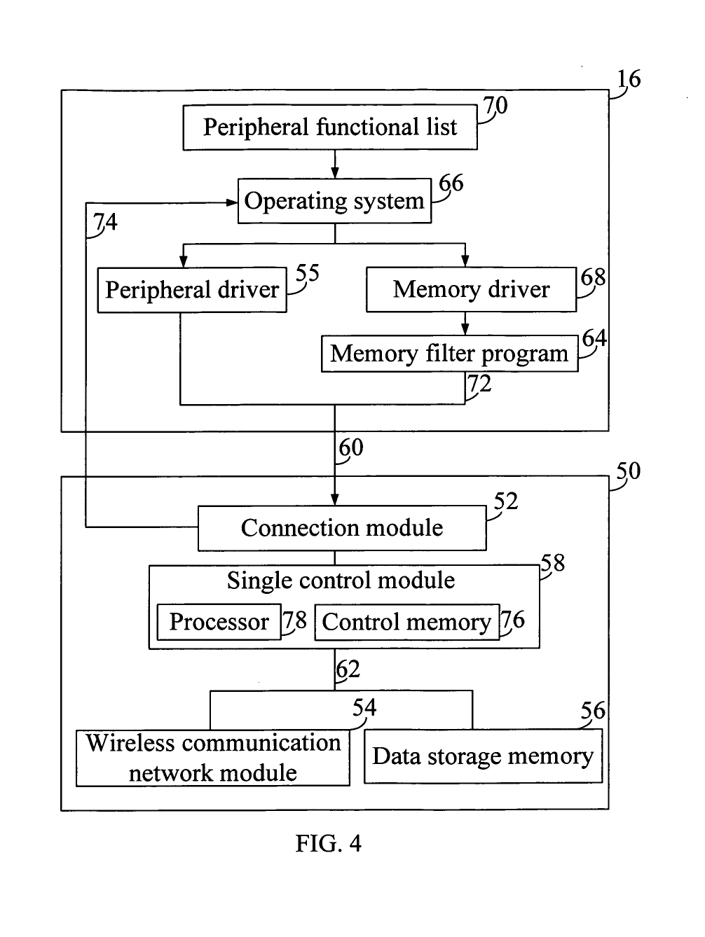

With reference to FIG. 3 and FIG. 4, FIG. 3 is a block diagram showing another embodiment of the multi-functional peripheral apparatus 50 of the present invention. FIG. 4 is a schematic diagram showing program installing and function switching after the multi-functional peripheral apparatus 50 is connected to the host 16 in FIG. 3. As shown in FIG. 3, the multi-functional peripheral apparatus 50 of the present invention comprises a connection module 52, a wireless communication network module 54, a data storage memory 56, and a control module 58. The wireless communication network module 54 and the data storage memory 56 are two peripheral modules of the multi-functional peripheral apparatus 50. The connection module 52 provides a transmission interface for receiving a peripheral output signal 60 from the host 16. The transmission interface is a universal serial bus.

The control module 58 receives the peripheral output signal 60 from the connection module 52 and generates a corresponding peripheral control command 62, so as to control and to enable a selected peripheral module specified in the peripheral output signal 60 to perform the corresponding specific peripheral function. The control module 58 comprises a control memory 76 and a processor 78. The control memory 76 is a read only memory for recording a firmware. The processor 78 reads the firmware and then, based upon the firmware and the peripheral output signal 60, generates the peripheral control command 62 to control the selected peripheral module.

The wireless communication network module 54 implements a wireless communication function. The wireless communication network module 54 comprises a wireless communication network unit 53, which meets the standard of IEEE 802.11a, IEEE 802.11g, or IEEE 802.11b. The wireless communication network module 54 supports WLAN, Bluetooth, or other wireless transmission standards in other descriptions.

The data storage memory 56 stores at least one a peripheral driver. One of the peripheral drivers is the peripheral driver 55 of the wireless communication network module 54. The data storage memory 56 further stores a memory filter program 64. The data storage memory 56 is a FLASH module with any size manufactured by any corporation in other descriptions.

As shown in FIG. 4, the host 16 comprises an built-in operating system 66 and a memory driver 68 active in the operating system. The operating system of the host 16 can be different kinds of operating system. When the multi-functional module apparatus 50 is connected to the host 16, the host 16 will allow the control module 58 to install the peripheral driver 55 of the wireless communication network module 54 into the host 16, so that the host can employ the driver 55 to drive the wireless communication network module 54.

When the multi-functional peripheral apparatus 50 is connected to the host 16, the host 6 will also allow the control module 58 to install the memory filter program 64, stored in the data storage memory 58, into the host 16.

When a selected peripheral module from a peripheral function list 70 offered by the host 16 is chosen, the memory filter program 64 is enabled by the operating system 66 to send a memory switch signal 72 to the control module 58 if a memory driver 68 has already been executed by the operating system 66.

When the control module 58 receives the memory switch signal 72 from the memory filter program 64, the control module 58 sends a changing signal 74 to the host 16, so that the operating system 66 will assume that the multi-functional peripheral apparatus 50 is disconnected with the host 16, and a recognizing process for the multi-functional peripheral apparatus 50 is performed in the host 16.

Only one of the plurality of peripheral modules in the multi-functional peripheral apparatus 50 is active to perform the corresponding peripheral function at a time.

The present invention also provides a method for establishing a signal transmission between a multi-functional peripheral apparatus and a host. Hereinafter, as illustrated in FIG. 3 and FIG. 4, the method for establishing a signal transmission between the multi-functional peripheral apparatus 50 and the host 16 is described in two parts. The first part is to about installing drivers and programs into the host 16, and the second part is about switching modules of the multi-functional peripheral apparatus 50 to perform corresponding functions.

First, the signal transmission of the installation is explained. When the multi-functional peripheral apparatus 50 is connected to the host 16, the host will allow the control module 44 to install the peripheral driver 55, stored in the data storage memory 56, into the host. After the multi-functional peripheral apparatus 50 is connected to the host 16, the host 16 installs the peripheral driver 55 and the memory filter program 64 into the host 16 through the connect module 52 by means of the control module 58.

Thus, the present invention provides an apparatus and a method for establishing a signal transmission between the multi-functional peripheral apparatus 50 and the host 16 for installing the peripheral driver 55 of the multi-functional peripheral apparatus 50. It is quite convenient that the peripheral driver is directly installed based upon the present invention without the need of an optical storage media storing the peripheral driver.

Then, the signal transmission of the switching of functions is explained. When the control module 58 receives the peripheral output signal 60 from the connection module 52, the control module 58 generates a corresponding peripheral control command to control and to enable a selected peripheral module specified in the peripheral output signal 60 to perform the corresponding specific peripheral function.

If the function of wireless communication network is to be executed, the wireless communication network module 54 needs to be first chosen from the peripheral function list 70 in the host 16. Then, the host 16 drives the corresponding peripheral driver 55 based upon the selected result. Next, the control module 58 drives the wireless communication network module 54 of the multi-functional peripheral apparatus 50 to perform the wireless communication.

If a data storage memory has already been executed in the host before switching to execute the wireless communication, the memory filter program must be enabled by the operating system 66, so as to send a memory switch signal 72 from the memory filter program 64 to the control module 58.

Afterwards, when the control module 58 receives the memory switch signal 72 from the memory filter program 64, the control module 58 sends a changing signal 74 to the host 16, so that the operating system 66 will assume that the multi-functional peripheral apparatus 50 is disconnected with the host 16, and a recognizing process for the multi-functional peripheral apparatus 50 is performed in the host 16.

Then, the operating system 66 of the host 16 recognizes the multi-functional peripheral apparatus 50 as a device with wireless communication network function and drives the peripheral driver 55 installed in the operating system 66. Next, the control module 58 drives the wireless communication network module 54 of the multi-functional peripheral apparatus 50 to perform wireless communication.

The above mentioned shows that the present invention employs software to switch between different functions and perform the corresponding peripheral function through a universal serial bus.

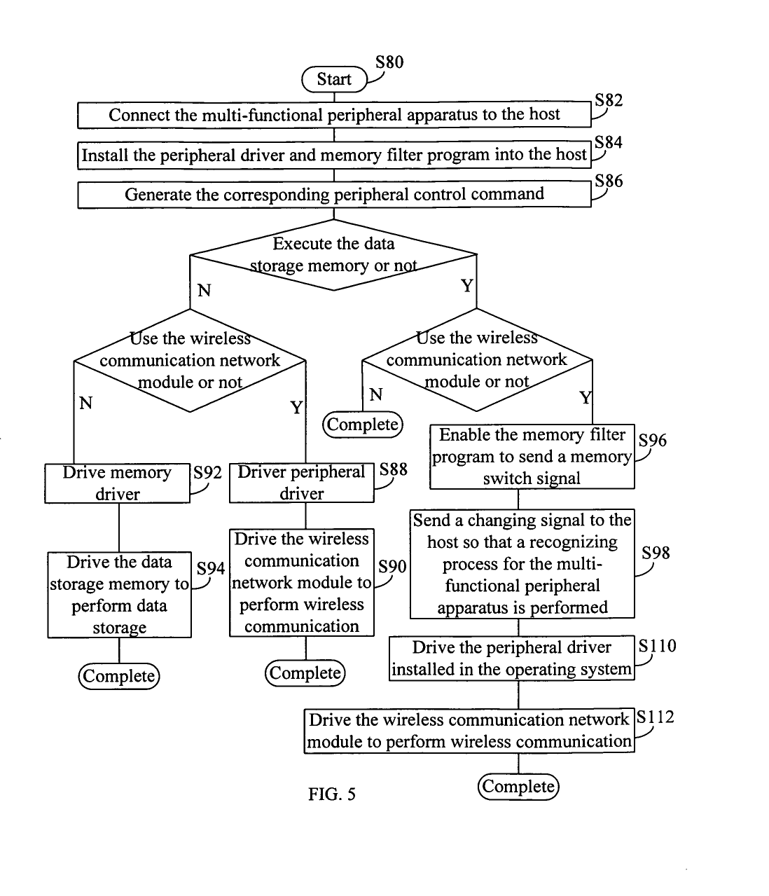

With reference to FIG. 5, FIG. 5 is a flow chart showing a signal transmission method for installing and function switching in the multi-functional peripheral apparatus 50 in FIG. 4. The present invention provides a method for establishing a signal transmission between a multi-functional peripheral apparatus and a host, and the method can be described by the following steps: installing through step 80 to step 84; switching functional modules to perform the corresponding peripheral function through step 86 to step 112. The following statement makes use of the multi-functional peripheral apparatus 50 and the host 16 of FIG. 3 and FIG. 4 to describe the method.
S80: Start;
S82: Connect the multi-functional peripheral apparatus 50 to the host 16;
S84: Install the peripheral driver 55, stored in the data storage memory 56, and the memory filter program 64 into the host 16 through the connection module 52 based upon the control module 58;
S86: When the control module 58 receives the peripheral output signal 60 from the connection module 52, the control module 58 generates the corresponding peripheral control command. At this time, if the data storage memory 56 has not been executed, and the wireless communication network module 54 is chosen, proceed from step 88 to step 90. If the data storage memory 56 has not been executed, and the data storage memory 56 is chosen, proceed from step 92 to step 94. If the data storage memory 56 has already been executed, and the wireless communication network module 54 is chosen, proceed from step 96 to step 112;
S88: If the data storage memory 56 has not been executed, and the wireless communication network module 54 is chosen, the host 16 drives the corresponding peripheral driver 55 of the wireless communication network module 54;
S90: The control module 58 drives the wireless communication network module 54 to perform wireless communication; end;
S92: If the data storage memory 56 has not been executed, and the data storage memory 56 is chosen, the host 16 drives the corresponding peripheral driver 68 of the data storage memory 56;
S94: The single control module 58 drives the data storage memory 56 to perform data storage; end;
S96: If the data storage memory 56 has already been executed, and the wireless communication network module 54 is chosen, the memory filter program 64 is enabled by the operating system 66 to send the memory switch signal 72 to the single control module 58;
S98: When the control module 58 receives the memory switch signal 72 from the memory filter program 64, the control module 58 sends a changing signal 74 to the host 16, so that the operating system 66 will assume that the multi-functional peripheral apparatus 50 is disconnected with the host 16, and a recognizing process for the multi-functional peripheral apparatus is performed in the host 16;
S110: The operating system 66 of the host 16 recognizes the multi-functional peripheral apparatus 50 as an apparatus with the wireless communication network function and drives the peripheral driver installed in the operating system 66;
S112: The control module 58 drives the wireless communication network module 54 of the multi-functional peripheral apparatus 50 to perform wireless communication. End.

Compared to the prior art, the apparatus and the method of the present invention for establishing a signal transmission between the multi-functional peripheral apparatus 50 and the host 16 employ software to switch between the different peripheral modules to perform corresponding specific peripheral functions through a universal serial bus. Therefore, the multi-functional peripheral apparatus of the present invention saves the cost of the hardware of the switch module and reduces the size of the apparatus. Furthermore, the present invention directly installs the peripheral driver through a connection between the multi-function peripheral apparatus and the host, without the need of an optical storage media storing the peripheral drivers.

With the example and explanations above, the features and spirits of the invention will be hopefully well described. Those skilled in the art will readily observe that numerous modifications and alterations of the device may be made when retaining the teaching of the invention. Accordingly, the above disclosure should be construed as limited only by the metes and bounds of the appended claims.

1. A multi-functional peripheral apparatus to be connected to a host, the multi-functional peripheral apparatus comprising:
a connection module providing a transmission interface to receive a peripheral output signal from the host;
a plurality of peripheral modules, each peripheral module performing a specific peripheral function, the plurality of peripheral modules further comprising a data storage memory storing at least a peripheral driver; and
a control module for receiving the peripheral output signal from the connection module and generating a corresponding peripheral control command to control and to enable a selected peripheral module specified in the peripheral output signal to perform the corresponding specific peripheral function;
when the multi-functional peripheral apparatus is connected to the host, the single control module installs the peripheral driver into the host so that the host employs the driver to drive the selected peripheral module.

2. The multi-functional peripheral apparatus of claim 1, wherein the data storage memory further stores a memory filter program, and when the multi-functional peripheral apparatus connects to the host, the control module installs the memory filter program into the host.

3. The multi-functional peripheral apparatus of claim 2, wherein the host comprises an operating system and a memory driver active in the operating system, and when the selected peripheral module is chosen, the operating system enables the memory filter program to send a memory switch signal to the control module.

4. The multi-functional peripheral apparatus of claim 3, when the control module receives the memory switch signal, the control module sends a changing signal to the host so that a recognizing process for the multi-functional peripheral apparatus is performed in the host.

5. The multi-functional peripheral apparatus of claim 2, wherein only one of the plurality of peripheral modules is active.

6. The multi-functional peripheral apparatus of claim 1, the control module comprising:
a control memory for recording a firmware; and
a processor for reading the firmware and then generating the peripheral control command to control the selected peripheral module based upon the firmware and the peripheral output signal.

7. The multi-functional peripheral apparatus of claim 6, wherein the control memory is a read only memory.

8. The multi-functional peripheral apparatus of claim 1, wherein the plurality of peripheral modules comprises a wireless communication network module.

9. The multi-functional peripheral apparatus of claim 8, wherein the wireless communication network module meets the standards of the IEEE 802.11a, the IEEE 802.11g, or the IEEE 802.11b.

10. The multi-functional peripheral apparatus of claim 1, wherein the transmission interface is a universal serial bus.

11. A method for establishing a signal transmission between a multi-functional peripheral apparatus and a host, the signal transmission method comprising:
(A) installing a peripheral driver into the host to drive the selected peripheral modules when the multi-functional peripheral apparatus is connected to the host; and
(B) receiving a peripheral output signal generated from the host; and
(C) based on the peripheral output signal, generating a corresponding peripheral control command to control and to enable a selected peripheral module of the multi-functional peripheral apparatus to perform the corresponding specific peripheral function.

12. The signal transmission method of claim 11, wherein the step (A) further comprises: installing a memory filter program into the host in which a memory driver is active.

13. The signal transmission method of claim 12, wherein the host generates the peripheral output signal in step (B) when the selected peripheral module from a peripheral function list offered by the host is chosen.

14. The signal transmission method of claim 13, the memory filter program is enabled if a data storage memory has already been executed in the host and the selected peripheral module is chosen.

15. The signal transmission method of claim 14, wherein a recognizing process for the multi-functional peripheral apparatus is performed in the host after the memory filter program is enabled.

16. The signal transmission method of claim 11, only one of the plurality of peripheral modules is active.
